(19) United States
(12) Patent Application Publication
(10) Pub. No.: US 2014/0315098 A1
(43) Pub. Date: Oct. 23, 2014

(54) SOLID ELECTROLYTE MICROPARTICLE PRODUCTION METHOD

(71) Applicant: Hiroyuki Inoue, Susono-shi (JP)

(72) Inventor: Hiroyuki Inoue, Susono-shi (JP)

(73) Assignee: TOYOTA JIDOSHA KABUSHIKI KAISHA, Toyota-shi, Aichi (JP)

(21) Appl. No.: 14/127,695

(22) PCT Filed: Jun. 20, 2011
(86) PCT No.: PCT/JP2011/064056

§ 371 Date: Mar. 13, 2014

(51) Int. Cl. H01M 10/0562; H01M 10/052

(52) U.S. Cl. CPC H01M 10/0562; H01M 10/052
USPC 429/304

(57) ABSTRACT

A method for producing solid electrolyte microparticles includes steps of: a preparation step of preparing a solid electrolyte solution by dissolving a solid electrolyte material in a good solvent; and a precipitation step of precipitating solid electrolyte microparticles by mixing the solid electrolyte solution into a poor solvent whose solubility to the solid electrolyte material is lower than that of the good solvent, wherein in the precipitation step, the solid electrolyte solution is mixed into the poor solvent such that in the mass ratio m:n between the mass “m” of the solid electrolyte solution and the mass “n” of the poor solvent, the proportion of the mass “n” of the poor solvent is increased to adjust the mass ratio to be higher than or equal to the mass ratio at which the solid electrolyte microparticles are precipitated.

### TECHNICAL FIELD

The present invention relates to a method for producing solid electrolyte microparticles, which enables stable production of solid electrolyte microparticles having a fine particle size that are used in, for example, all-solid batteries.

### BACKGROUND ART

Along with the rapid distribution in recent years of information-related equipment and communication equipment, such as personal computers, video cameras, and mobile telephones, development of batteries that are used as power supplies has been considered important. Furthermore, also in the automobile industry and other industries, development of high power output and high capacity batteries for electric cars or hybrid cars is in progress. Currently, among various batteries, attention is paid to lithium batteries from the viewpoint of having high energy density.

Those lithium batteries that are currently commercially available use liquid electrolytes containing flammable organic solvents. Therefore, improvement is required in terms of the installation of a safety device for suppressing temperature increase at the time of a short circuit, or in terms of the structure and material for the prevention of short circuits. In this regard, it is contemplated that since a lithium battery obtained by making a battery all-solid by changing the liquid electrolyte to a solid electrolyte layer, does not use a flammable organic solvent inside the battery, simplification of the safety device may be attempted, and excellent production cost or productivity may be obtained.

Regarding a method for producing a solid electrolyte material used in all-solid batteries, Patent Literature 1 discloses a method of forming a solid electrolyte material using metal lithium, elemental sulfur, elemental phosphorus and the like as raw materials, and using mechanical milling. Furthermore, Patent Literature 2 discloses a method of forming a solid electrolyte material by allowing lithium components, sulfur components, elemental phosphor, and the like to react in an organic solvent. It has also been disclosed in regard to a solid electrolyte material formed in an organic solvent that precipitation is induced by pouring a solvent having low solubility to the solid electrolyte material.

### CITATION LIST

### Patent Literature

Patent Literature 1: Japanese Patent Application Publication (JP-A) No. 2003-208919

Patent Literature 2: WO 2004/093099 A

### SUMMARY OF INVENTION

### Technical Problem

However, in the field of all-solid batteries, there is a demand for a solid electrolyte layer formed from an even thinner film, for the purpose of an increase in the capacity of batteries. Also, for an enhancement of the battery performance, it is required to increase the contact area of the active material layer and the solid electrolyte layer. Therefore, in order to form a solid electrolyte layer constructed from a thin film and having a large contact area with the active material layer or the like, it is required that a smaller particle size be used in a solid electrolyte material.

However, in the conventional method for producing a solid electrolyte material using mechanical milling, the particle size of the solid electrolyte material thus obtainable is limited to about 1 μm, and there is a problem that it is difficult to obtain an even smaller particle size. On the other hand, in regard to the method described in Patent Literature 2 for producing a solid electrolyte material using an organic solvent, the method for controlling the particle size of the solid electrolyte material thus obtainable is not established, and there is a problem that it is difficult to stably produce a solid electrolyte material having a fine particle size.

The present invention was achieved in view of such circumstances, and it is a main object of the present invention to provide a method for producing solid electrolyte microparticles capable of stably producing solid electrolyte microparticles having a fine particle size.

### Solution to Problem

In order to achieve the object described above, the inventor of the present invention paid attention to the conditions employed when a solid electrolyte material dissolved in a solvent having high solubility to the solid electrolyte material (good solvent) is precipitated using a poor solvent, and conducted a thorough investigation. As a result, the inventor discovered that the mass ratio of the mass of the poor solvent and the mass of the solid electrolyte solution that is added dropwise to the poor solvent is correlated to the particle size of the solid electrolyte microparticles precipitated, and found that solid electrolyte microparticles having a desired particle size can be precipitated in a stable manner by adjusting the mass ratio described above to a predetermined range. Thus, the inventor finally completed the present invention.

That is, the present invention provides a method for producing a solid electrolyte microparticle comprising steps of: a preparation step of preparing a solid electrolyte solution by dissolving a solid electrolyte material in a good solvent; and a precipitation step of precipitating a solid electrolyte microparticle by mixing the solid electrolyte solution into a poor solvent whose solubility to the solid electrolyte material is lower than that of the good solvent, characterized in that in the precipitation step, the solid electrolyte solution is mixed into the poor solvent such that in the mass ratio m:n between amass “m” of the solid electrolyte solution and amass “n” of the poor solvent, the proportion of the mass “n” of the poor solvent is increased to adjust the mass ratio to be higher than or equal to the mass ratio at which the solid electrolyte microparticles are precipitated.

According to the present invention, in the precipitation step, when the solid electrolyte layer solution is mixed into the poor solvent such that the proportion of the mass “n” of the poor solvent is increased to adjust the mass ratio m:n to be higher than or equal to the mass ratio described above, solid electrolyte microparticles having a fine particle size can be produced in a stable manner.

In the invention described above, the solid electrolyte material is preferably a sulfide solid electrolyte material. It is because a sulfide solid electrolyte material has high Li ion conductivity, and can produce a high power output battery when used in a solid electrolyte layer of an all-solid battery, or in an electrode active material layer.

In the invention described above, it is preferable that the relative permittivity difference between a relative permittivity of the good solvent and a relative permittivity of the poor solvent be 30 or less. Since a compatibility of the good solvent and the poor solvent can be further increased, solid electrolyte microparticles having a finer particle size can be produced.

### Advantageous Effects of Invention

The present invention offers an effect that a method for producing solid electrolyte microparticles, which is capable of stably producing solid electrolyte microparticles having a fine particle size, can be provided.

### BRIEF DESCRIPTION OF DRAWINGS

FIGS. 1A to 1D are process diagrams each illustrating an example of the method for producing solid electrolyte microparticles of the present invention.

### DESCRIPTION OF EMBODIMENTS

Hereinafter, the method for producing solid electrolyte microparticles of the present invention will be described.

The method for producing solid electrolyte microparticles of the present invention is a production method comprising steps of: a preparation step of preparing a solid electrolyte solution by dissolving a solid electrolyte material in a good solvent; and a precipitation step of precipitating solid electrolyte microparticles by mixing the solid electrolyte solution into a poor solvent whose solubility to the solid electrolyte material is lower than that of the good solvent, characterized in that in the precipitation step, the solid electrolyte solution is mixed into the poor solvent such that in the mass ratio m:n between the mass “m” of the solid electrolyte solution and the mass “n” of the poor solvent, the proportion of the mass “n” of the poor solvent is increased to adjust the mass ratio to be higher than or equal to the mass ratio at which the solid electrolyte microparticles are precipitated.

Incidentally, in the present invention, a good solvent refers to a solvent capable of dissolving the solid electrolyte material. More specifically, the good solvent maybe a solvent which is capable of dissolving the solid electrolyte material at the temperature of the solvent used during the preparation step and the precipitation step even if a small amount of the solvent is used, and even more specifically, the good solvent refers to a solvent in which the mass of a solid electrolyte material that dissolves in 100 g of the solvent (solubility) is 0.1 g or more.

On the other hand, a poor solvent refers to a solvent whose solubility to the solid electrolyte material is smaller than the solubility of the good solvent described above. More specifically, the poor solvent refers to a solvent in which the mass of a solid electrolyte material that dissolves in 100 g of the solvent (solubility) is 0 g at the temperature of the solvent used during the precipitation step.

Furthermore, in the present invention, the “mass ratio at which solid electrolyte microparticles are precipitated” refers to the mass ratio at which when the solid electrolyte solution of mass “m” is mixed into the poor solvent of mass “n”, the solid electrolyte material thus precipitated forms solid electrolyte microparticles in the form of microparticles. Furthermore, regarding the solid electrolyte microparticles according to the present invention, it is implied that the particle size of the microparticles is smaller than the particle size of the solid electrolyte material of the raw material before being dissolved in the good solvent in the preparation step.

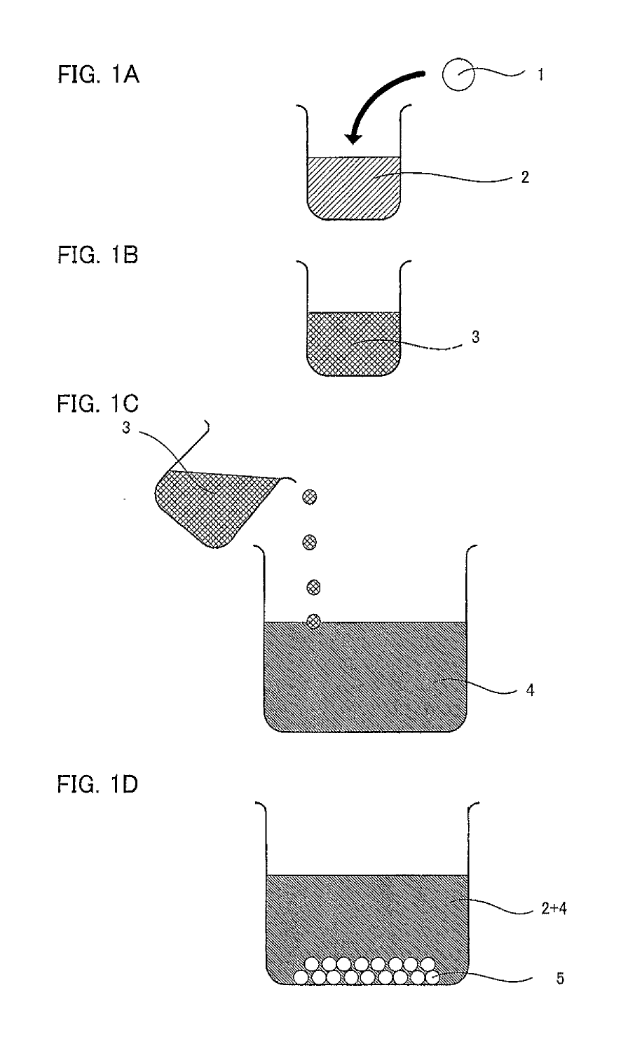

Here, the method for producing solid electrolyte microparticles of the present invention will be described using the drawings. FIGS. 1A to 1D are process diagrams each illustrating an example of the method for producing solid electrolyte microparticles of the present invention. The method for producing solid electrolyte microparticles 5 of the present invention is a production method comprising steps of a preparation step of dissolving a solid electrolyte material 1 in a good solvent 2 (FIG. 1A) and thereby preparing a solid electrolyte solution 3 (FIG. 1B); and a precipitation step of mixing the solid electrolyte solution 3 into a poor solvent 4 (FIG. 1C) and thereby precipitating solid electrolyte microparticles 5 (FIG. 1D). Furthermore, the production method is characterized in that in the precipitation step, the solid electrolyte solution 3 is mixed into the poor solvent 4 such that in the mass ratio m:n between the mass “m” of the solid electrolyte solution 3 and the mass “n” of the poor solvent 4, the proportion of the mass “n” of the poor solvent 4 is increased to adjust the mass ratio to be higher than or equal to the mass ratio at which the solid electrolyte microparticles 5 are precipitated. Furthermore, in the precipitation step, the solid electrolyte microparticles 5 are precipitated in a mixed solvent (2+4) of the good solvent 2 and the poor solvent 4.

Here, in the present invention, the reason why solid electrolyte microparticles having a fine particle size can be precipitated by adjusting the mass ratio m:n between the mass “m” of a solid electrolyte solution and the mass “n” of a poor solvent as described above is not clearly known, but the reason is speculated as follows. That is, precipitation of the solid electrolyte microparticles occurs because the solubility of the solid electrolyte material in the solid electrolyte solution mixed into the poor solvent is decreased. It is speculated that at this time, as the mass of the solid electrolyte solution mixed into the poor solvent is larger, the solid electrolyte solution is dispersed in the form of larger particles in the poor solvent. Furthermore, it is speculated that since the content of the solid electrolyte material in the solid electrolyte solution in the form of large particles is high as such, when particles are precipitated, the particulate solid electrolyte material in the solid electrolyte solution aggregates and precipitates into particles having a larger particle size. On the other hand, it is speculated that as the mass of the solid electrolyte solution mixed into the poor solvent is smaller, the solid electrolyte solution is dispersed in the form of smaller particles in the poor solvent. Furthermore, in regard to the solid electrolyte solution in the form of smaller particles as such, it is speculated that since the content of the solid electrolyte material is small, the solid electrolyte solution is precipitated into particles having a smaller particle size when the particles are precipitated.

The present invention is characterized by finding that the mass ratio m n described above is correlated to the particle size of the solid electrolyte microparticles to be precipitated. That is, according to the present invention, when the solid electrolyte layer solution is mixed into the poor solvent in the precipitation step such that the proportion of the mass of the poor solvent is increased to adjust the mass ratio m:n to be higher than or equal to the mass ratio described above, solid electrolyte microparticles having a fine particle size can be produced in a stable manner.

Hereinafter, the various processes of the method for producing solid electrolyte microparticles of the present invention will be explained.

1. Preparation Step

The preparation step according to the present invention is a process of preparing a solid electrolyte solution by dissolving a solid electrolyte material in a good solvent.

The solid electrolyte material used in the present process is not particularly limited as long as the material has ion conductivity, and the same material as that used in the solid electrolyte layer of general all-solid batteries can be used. Specific examples thereof include sulfide solid electrolyte materials and oxide solid electrolyte materials, and among them, the solid electrolyte material is preferably a sulfide solid electrolyte material. It is because the sulfide solid electrolyte material has high Li ion conductivity, and when the material is used in an all-solid battery, a high power output battery can be obtained.

A sulfide solid electrolyte material usually contains a metal element (M) that becomes the ion to be conducted, and sulfur (S). Examples of the element M include Li, Na, K, Mg and Ca, and among them, Li is preferred. Particularly, it is preferable that the sulfide solid electrolyte material contain Li, A (A represents at least one selected from the group consisting of P, Si, Ge, Al and B), and S. Furthermore, the element A is preferably P (phosphorus). Furthermore, the sulfide solid electrolyte material may contain halogen such as Cl, Br or I. It is because when the sulfide solid electrolyte material contains halogen, ion conductivity increases. Also, the sulfide solid electrolyte material may contain O.

Examples of the sulfide solid electrolyte material having Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which “m” and “n” represent positive numbers; and Z represents any one of Ge, Zn and Ga) Li₂S—GeS₂, Li₂S—SiS₂—Li₃PO₄, and Li₂S—SiS₂—LiₓMO_{y} (in which “x” and “y” represent positive numbers; and M represents any one of P, Si, Ge, B, Al, Ga and In). Incidentally, the description of “Li₂S—P₂S₅” means a sulfide solid electrolyte material formed using a raw material composition containing Li₂S and P₂S₅, and the same also applies to other descriptions.

Furthermore, when the sulfide solid electrolyte material is formed using a raw material composition containing Li₂S and P₂S₅, the proportion of Li₂S relative to the sum of Li₂S and P₂S₅ is, for example, preferably in the range of 70 mol % to 80 mol %, more preferably in the range of 72 mol % to 78 mol %, and even more preferably in the range of 74 mol % to 76 mol %. It is because a sulfide solid electrolyte material having an ortho composition or a composition close thereto can be obtained, and a sulfide solid electrolyte material having high chemical stability can be obtained. Here, the term ortho generally means a composition having the highest degree of hydration among the oxo acids obtainable by hydrating the same oxide. In the present invention, a crystal composition in which Li₂S has been added to the largest extent to the sulfide is called an ortho composition. In the Li₂S—P₂S₅ system, Li₃PS₄ corresponds to the ortho composition. In the case of a sulfide solid electrolyte material of the Li₂S—P₂S₅ system, the ratio of Li₂S and P₂S₅ to obtain the ortho composition is, on a molar basis, Li₂S:P₂S₅=75:25. Incidentally, even when Al₂S₃ or B₂S₃ is used instead of P₂S₅ in the raw material composition described above, the preferred range is the same. In the Li₂S—Al₂S₃ system, Li₃AlS₃ corresponds to the ortho composition, and in the Li₂S—B₂S₃ system, Li₃BS₃ corresponds to the ortho composition.

Furthermore, when the sulfide solid electrolyte material is formed using a raw material composition containing Li₂S and SiS₂, the ratio of Li₂S relative to the sum of Li₂S and SiS₂ is, for example, preferably in the range of 60 mol % to 72 mol %, more preferably in the range of 62 mol % to 70 mol %, and even more preferably in the range of 64 mol % to 68 mol %. It is because a sulfide solid electrolyte material having an ortho composition or a composition close thereto can be obtained, and a sulfide solid electrolyte material having high chemical stability can be obtained. In the Li₂S—SiS₂ system, Li₄SiS₄ corresponds to the ortho composition. In the case of a sulfide solid electrolyte material of the Li₂S—SiS₂ system, the ratio of Li₂S and SiS₂ to obtain the ortho composition is, on a molar basis, Li₂S:SiS₂=66.6:33.3. Incidentally, even when GeS₂ is used instead of SiS₂ in the raw material composition described above, the preferred range is the same. In the Li₂S—GeS₂ system, Li₄GeS₄ corresponds to the ortho composition.

Furthermore, when the sulfide solid electrolyte material is formed using a raw material composition containing TAX (X=Cl, Br or I), the proportion of LiX is for example, preferably in the range of 1 mol % to 60 mol %, more preferably in the range of 5 mol % to 50 mol %, and even more preferably in the range of 10 mol % to 40 mol %.

Furthermore, the sulfide solid electrolyte material may be a sulfide glass, may be a crystallized sulfide glass, or may be a crystalline material obtainable by a solid phase method. Incidentally, the sulfide glass can be obtained by, for example, subjecting the raw material composition to mechanical milling (ball mill or the like). Furthermore, the crystallized sulfide glass can be obtained by, for example, subjecting the sulfide glass to a heat treatment at a temperature higher than or equal to the crystallization temperature. Furthermore, when the sulfide solid electrolyte material is a Li ion conductor, the Li ion conductivity at normal temperature is, for example, preferably 1×10⁻⁵ S/cm or higher, and more preferably 1×10⁻⁴ S/cm or higher.

The average particle size (D₅₀) of the solid electrolyte material before being dissolved in the good solvent (raw material) is not particularly limited as long as solid electrolyte microparticles having a smaller particle size than the solid electrolyte material can be obtained in the precipitation process that will be described below. Specifically, when the solid electrolyte material is a sulfide solid electrolyte material, the average particle size is preferably 1 μm or greater, among them, preferably in the range of 2 μm to 100 μm, and particularly preferably in the range of 2 μm to 40 μm. Incidentally, the average particle size (D₅₀) of the solid electrolyte material can be determined using, for example, a particle size analyzer.

The good solvent as used in the present process is not particularly limited as long as the solvent is capable of dissolving the solid electrolyte material, and more specifically has a solubility to the solid electrolyte material in the range described above and does not deteriorate the solid electrolyte material.

Furthermore, the relative permittivity of the good solvent is not particularly limited as long as the solvent is capable of dissolving a solid electrolyte material, and is capable of precipitating solid electrolyte microparticles by mixing a solid electrolyte solution into a poor solvent in the precipitation step that will be described below.

Incidentally, regarding the “relative permittivity of the solvent” according to the present invention, those described in the Chemical Society of Japan, ed. “Kagaku Binran Kiso-hen II (Handbook of Chemistry: Fundamentals II)”, Revised 4^{th} Edition, Maruzen Co., Ltd., pp. 499-501, can be employed.

Furthermore, the relative permittivity of the solvent can also be determined according to the following measurement method. That is, a solvent to be measured is filled between two sheets of electrode plates, a voltage is applied at a high frequency, and then the current value is measured. Thus, the relative permittivity can be derived. More specifically, the relative permittivity can be measured using, for example, a dielectric constant meter manufactured by Nihon Rufuto Co., Ltd.

Specific examples of such a good solvent include aprotic polar organic solvents. Incidentally, examples of the aprotic polar organic solvents include lactam compounds such as N-methyl-2-pyrrolidone (NMP); amide compounds such as dimethylformamide; and urea compounds such as tetramethylurea, and among them, the aprotic polar organic solvent is preferably NMP.

The solid electrolyte solution obtainable by the present process is not particularly limited as long as the solution contains a desired amount of the solid electrolyte material in the good solvent described above, but the solid electrolyte solution is preferably a saturated solution. It is because solid electrolyte microparticles can be suitably precipitated in the precipitation step that will be described below.

Furthermore, the temperature of the good solvent in the preparation step is not particularly limited as long as a desired amount of the solid electrolyte material can be dissolved in the good solvent at that temperature, and the solid electrolyte material is not deteriorated. Specifically, the temperature is preferably 200° C. or lower, and particularly preferably 60° C. or lower. Incidentally, the lower limit can be set to a temperature at which the solvent is in the liquid state (melting point of the solvent) It is because when the temperature of the good solvent is adjusted to the range described above, the solid electrolyte material can be suitably dissolved.

2. Precipitation Step

The precipitation step according to the present invention is a step of precipitating solid electrolyte microparticles by mixing the solid electrolyte solution into a poor solvent whose solubility of the solid electrolyte material is lower than that of the good solvent, and is characterized in that the solid electrolyte solution is mixed into the poor solvent such that in the mass ratio m:n of the mass “m” of the solid electrolyte solution and the mass “n” of the poor solvent, the proportion of the mass “n” of the poor solvent is increased to adjust the mass ratio to be higher than or equal to the mass ratio at which the solid electrolyte microparticles are precipitated.

The poor solvent used in the present process is not particularly limited as long as the solubility to the solid electrolyte material is lower than that of the good solvent, and more specifically, the solubility to the solid electrolyte material is in the range described above; however, a poor solvent having high compatibility with the good solvent is more preferred. It is because as the compatibility of the good solvent and the poor solvent is higher, the particle size of the solid electrolyte microparticles precipitated can be made smaller.

Here, the reason why as the compatibility of the good solvent and the poor solvent is higher, the particle size of the solid electrolyte microparticles can be made smaller is not clearly understood, but the reason is speculated as follows. As described above, it is speculated that the solid electrolyte solution mixed into the poor solvent is dispersed in a particulate form; however, it is contemplated that as the compatibility of the good solvent and the poor solvent increases, the solid electrolyte solution in a particulate form becomes even smaller. Therefore, it is speculated that since the content of the solid electrolyte material in the solid electrolyte solution in the form of smaller particles is small, the particle size of the solid electrolyte microparticles precipitated is decreased.

Here, in regard to the compatibility between the good solvent and the poor solvent, as the relative permittivities of the respective solvents are closer to each other, the compatibility becomes larger. The difference in relative permittivity between the relative permittivity of the good solvent and the relative permittivity of the poor solvent is not particularly limited as long as solid electrolyte microparticles having a desired particle size can be precipitated; however, the difference in relative permittivity is preferably 30 or less, and particularly preferably 28 or less. It is because when the difference in relative permittivity is greater than the range described above, since the compatibility between the good solvent and the poor solvent is not sufficient, there is a possibility that it may be difficult to precipitate the solid electrolyte material itself from the solid electrolyte solution. Incidentally, the lower limit of the difference in relative permittivity can be set to about 10.

Furthermore, the relative permittivity of the poor solvent used in the present invention is not particularly limited as long as the difference in relative permittivity between the relative permittivity of the poor solvent and the relative permittivity of the good solvent can be adjusted to the range described above; however, when the solid electrolyte material is a sulfide solid electrolyte material, and the good solvent is an aprotic polar organic solvent such as described above, the relative permittivity of the poor solvent is preferably 2 or higher, and among others, preferably 4 or higher.

Specific examples of such a poor solvent include toluene, cyclopentyl methyl ether, and butyl acrylate.

Furthermore, in the present process, the poor solvent described above and a poor solvent which does not exhibit compatibility with the good solvent (non-compatible solvent) may be mixed and used.

The non-compatible solvent may be heptane or the like, when the good solvent is the solvent described above.

The mass ratio m:n between the mass “m” of the solid electrolyte solution and the mass “n” of the poor solvent is not particularly limited as long as the mass ratio is a mass ratio at which the proportion of the mass “n” of the poor solvent is increased to adjust the mass ratio m:n to be higher than or equal to the mass ratio at which the solid electrolyte microparticles are precipitated. Incidentally, the mass “m” of the solid electrolyte solution is the entire amount of the solid electrolyte solution that is mixed into the poor solvent. The mass ratio m:n is to be appropriately adjusted in consideration of factors such as the kind of the solid electrolyte material, the combination of the good solvent and the poor solvent, the concentration of the solid electrolyte solution, and the desired particle size of the solid electrolyte microparticles.

Regarding a preferred mass ratio m:n according to the present invention, when the solid electrolyte solution is a saturated solution of a sulfide solid electrolyte material and a specific good solvent described above, and the poor solvent is a specific poor solvent described above, the mass ratio is preferably 1:1 or higher (ratio at which “n” is 1 or more when “m” is 1), and particularly preferably 1:10 or higher (ratio at which “n” is 10 or higher when “m” is 1). It is because if the mass of the solid electrolyte solution is too large relative to the mass of the poor solvent, there is a possibility that it may be difficult to make the particle size of the solid electrolyte microparticles thus obtainable sufficiently small. It is also because if the mass of the solid electrolyte solution is too small relative to the mass of the poor solvent, since the amount of the poor solvent becomes excess, there is a possibility that the production cost may increase.

The temperature of the solid electrolyte solution for the precipitation step can be set to be the same temperature as the temperature of the good solvent in the preparation step described above.

Furthermore, the temperature of the poor solvent for the precipitation step is not particularly limited as long as solid electrolyte microparticles can be precipitated and the solid electrolyte microparticles are not deteriorated at the temperature. In the present process, among others, the temperature of the poor solvent is preferably the same temperature as the temperature of the solid electrolyte solution. It is because solid electrolyte microparticles can be precipitated more stably.

The method of mixing the solid electrolyte solution in the present process is not particularly limited if the method is a method capable of uniformly mixing the solid electrolyte solution into the poor solvent and solid electrolyte microparticles having a desired particle size can be precipitated. Examples of the method include a method of continuously pouring the entire amount of the solid electrolyte solution while the poor solvent is stirred; and a method of adding the solid electrolyte solution dropwise several times in small amounts while the poor solvent is stirred. Among them, the method of adding the solid electrolyte solution dropwise can be suitably used. It is because when the method described above is used, the particle size of the solid electrolyte microparticles thus obtainable can be made more uniform.

3. Other Processes

The method for producing solid electrolyte microparticles of the present invention is not particularly limited as long as it is a production method comprising the preparation step and the precipitation step described above, and may appropriately select and include other necessary processes in addition to those. Examples of these processes include a process of washing the solid electrolyte microparticles thus obtained; and a process of drying the solid electrolyte microparticles.

4. Solid Electrolyte Microparticles

In the present invention, solid electrolyte microparticles having a desired fine particle size can be obtained by adjusting various conditions such as the solid electrolyte material, the combination of the good solvent and the poor solvent, the concentration of the solid electrolyte solution, and the mass ratio m:n.

The average particle size (D₅₀) of the solid electrolyte microparticles is not particularly limited as long as a solid electrolyte layer can be made into a thin film when the solid electrolyte microparticles are used in the solid electrolyte layer of an all-solid battery, and the solid electrolyte layer can be made highly adhesive to an active material layer. For example, when the solid electrolyte microparticles are sulfide solid electrolyte microparticles, the average particle size is preferably 1.63 μm or less, and among others, preferably in the range of 0.05 μm to 1 μm.

The solid electrolyte microparticles obtainable by the production method of the present invention can be used for any applications where ion conductivity is required, but among others, the solid electrolyte microparticles are preferably used in all-solid batteries.

Incidentally, the present invention is not intended to be limited to the exemplary embodiments described above. The above-described exemplary embodiments are only for illustrative purposes, and any embodiments having substantially the same constitution as the technical idea described in the claims of the present invention and provide the same operating effect, are also included in the technical scope of the present invention.

### EXAMPLES

Hereinafter, the present invention will be more specifically described by way of Examples.

Incidentally, unless particularly stated otherwise on the following descriptions, the poor solvent is a solvent having compatibility with NMP.

Furthermore, regarding the temperatures of the good solvent, solid electrolyte solution and poor solvent employed in the production processes for sulfide solid electrolyte microparticles of the following Examples 1 to 5, the production processes were carried out under the conditions of the good solvent (25° C.), the solid electrolyte solution (25° C.), and the poor solvent (25° C.)

### Example 1

Li₂S and P₂S₅ were mixed at a quantitative ratio, and the mixture was subjected to mechanical milling. Thus, Li₃PS₄ was obtained as a sulfide solid electrolyte material. The particle size of the sulfide solid electrolyte material thus obtained was about 25 μm.

A solid electrolyte solution in which the sulfide solid electrolyte material was dissolved in NMP (relative permittivity: 32) at a concentration of 1 w % was prepared.

Next, the solid electrolyte solution thus obtained was added dropwise to toluene (relative permittivity: 2.3) as a poor solvent such that the mass ratio m:n between the mass “m” of the solid electrolyte solution and the mass “n” of the poor solvent would be 1:10, and thereby sulfide solid electrolyte microparticles were precipitated.

### Example 2

Sulfide solid electrolyte microparticles were precipitated in the same manner as in Example 1, except that cyclopentyl methyl ether (relative permittivity: 4.7) was used as the poor solvent.

### Example 3

Sulfide solid electrolyte microparticles were precipitated in the same manner as in Example 1, except that butyl acrylate (relative permittivity: 5.0) was used as the poor solvent.

### Example 4

Sulfide solid electrolyte microparticles were precipitated in the same manner as in Example 1, except that a mixed solvent obtained by adding 10 w % of 2-ethylhexanol (relative permittivity: 7.7) to heptane (relative permittivity: 1.9) was used as the poor solvent. Incidentally, heptane is a solvent that does not have compatibility with NMP.

### Example 5

A sulfide solid electrolyte was precipitated by adding dropwise the solid electrolyte solution into heptane in the same manner as in Example 1, except that heptane (relative permittivity: 1.9) was used as the poor solvent. Incidentally, the sulfide solid electrolyte microparticles thus obtainable had a particle size of 5 μm or greater.

[Evaluation]

The sulfide solid electrolyte microparticles obtained in Examples 1 to 5 were observed using a scanning electron microscope (SEM™, manufactured by JEOL, Ltd.), and the particle size (D₅₀) (average particle size) was measured. The results are presented in Table 1.

TABLE 1

| | Example 1 | Example 2 | Example 3 | Example 4 | Example 5 |
|---|---|---|---|---|---|
| Particle size | 1.63 | 0.84 | 0.58 | 2.3 | 10.69 |
| D₅₀ (μm) | | | | | |

It could be confirmed that solid electrolyte microparticles having a small particle size may be obtained by adjusting the mass ratio m:n to a predetermined amount, and by adding the solid electrolyte solution dropwise to a poor solvent.

### REFERENCE SIGNS LIST

1 SOLID ELECTROLYTE MATERIAL
2 GOOD SOLVENT
3 SOLID ELECTROLYTE SOLUTION
4 POOR SOLVENT
5 SOLID ELECTROLYTE MICROPARTICLES

1-3. (canceled)

4. A method for producing a solid electrolyte microparticle, the method comprising steps of:
a step of obtaining a solid electrolyte material by a mechanical milling method;
a preparation step of preparing a solid electrolyte solution by dissolving the solid electrolyte material in a good solvent; and
a precipitation step of precipitating a solid electrolyte microparticle by mixing the solid electrolyte solution into a poor solvent whose solubility to the solid electrolyte material is lower than that of the good solvent,
wherein in the precipitation step, in the mass ratio m n between a mass “m” of the solid electrolyte solution and a mass “n” of the poor solvent, the proportion of the mass “n” of the poor solvent is increased to adjust the mass ratio to be higher than or equal to a mass ratio at which the solid electrolyte microparticle is precipitated.

5. The method for producing a solid electrolyte microparticle according to claim 4, wherein the solid electrolyte material is a sulfide solid electrolyte material.

6. The method for producing a solid electrolyte microparticle according to claim 4, wherein a difference in relative permittivity between a relative permittivity of the good solvent and a relative permittivity of the poor solvent is 30 or less.

7. The method for producing a solid electrolyte microparticle according to claim 5, wherein a difference in relative permittivity between a relative permittivity of the good solvent and a relative permittivity of the poor solvent is 30 or less.
